(19) United States
(12) Patent Application Publication
(10) Pub. No.: US 2026/0078610 A1
(43) Pub. Date: Mar. 19, 2026

(54) BOLT MODULE WITH SIEGE BUTTON AND LATCH

(71) Applicant: Surelock McGill Limited, Wokingham (GB)

(72) Inventor: Craig Murray, Sandhurst (GB)

(21) Appl. No.: 19/327,597

(22) Filed: Sep. 12, 2025

(30) Foreign Application Priority Data
Sep. 17, 2024 (GB) 2413650.9

(51) Int. Cl. E05B 63/00; E05B 41/00; E05B 47/00

(52) U.S. Cl. CPC E05B 63/0065; E05B 41/00; E05B 47/0002; E05B 2063/0082

(57) ABSTRACT

A bolting mechanism with a lockdown mode is provided. The bolting mechanism includes at least one bolt, the bolt moveable between a thrown position for securing a door and a retracted position, at least one first rotor arranged to simultaneously drive the bolt and one or more drive members, a first bias arranged to drive the at least one first rotor to urge the bolt to the thrown position, and a lockdown assembly comprising a lockdown button and plunger. The plunger is movable between a blocking position and a retracted position wherein the plunger is biased by a second bias to engage with one of the drive members and block throwing of the at least one bolt. The lockdown button is arranged to release the plunger so the first bias throws the bolt or primes the bolt ready to be urged to the thrown position.

### RELATED APPLICATIONS

This application claims priority to United Kingdom application number 2413650.9, filed Sep. 17, 2024, the disclosure of which is incorporated herein by reference in its entirety.

### TECHNICAL FIELD

The present invention relates to a bolting mechanism for securing a door or leaf. In particular, the bolting mechanism includes a lockdown mode such as for rapidly throwing one or more bolts of the bolting mechanism.

### BACKGROUND

A prior art bolting mechanism incorporating a deadbolt is disclosed in GB 2413822. The bolting mechanism is a multi-point bolting mechanism providing bolts that move to secure a door, or leaf, at the top, bottom and opening side of the door or leaf. An example multi-point bolting system on a door 2 is shown in FIG. 1. The central bolting mechanism that drives the bolts is indicated by 1 in the figure. The bolts that move to secure the top and bottom of the door are indicated by 4 and the bolt for securing the opening side of the door is indicated by 5. The three bolts are thrown and retracted together by operation of the central bolting mechanism 1. The central bolting mechanism 1 is configured such that one of the bolts or a drive member driving one of the bolts, for example the bolt that moves to secure the top of the door, may have its movement blocked by a deadbolt or latch that engages in a recess in the bolt. Since all three bolts are driven together, by securing one of the bolts against movement, all of the bolts are secured. Throwing of the deadbolt or latch to block movement of the bolts is provided by operation of a key cylinder. With the deadbolt or latch released, the bolts may be thrown or retracted by rotation of handle shown in FIG. 1.

FIG. 2 shows the internal components of a bolting mechanism 10 similar to that of FIG. 1. The bolting mechanism of FIG. 2 differs from that of FIG. 1 in that FIG. 2 comprises a single bolt. The arrangement may be readily modified to a multi-point bolting mechanism, as we will describe in the following paragraphs. In FIG. 2, the bolt 11 is shown in a position extending laterally from the bolting mechanism 10, such as for securing a door at its opening side. The bolt 11 can be moved laterally between a thrown position and a retracted position. The bolting mechanism comprises a rotor 20 which may be driven by a handle (not shown). Rotor 20 has teeth engaging with teeth on the bolt. Rotation of the rotor 20, as shown by arrow B in FIG. 2, may retract the bolt. The bolting mechanism may further comprise drive member 30 which also has teeth engaging with rotor 20. Rotation of the rotor 20 may be blocked by drive member 30 if a sliding deadbolt 40 is positioned to extend into an aperture 32 in the drive member 30. The position of the sliding deadbolt 40 is determined by use of a key cylinder 50 or solenoid 60. The sliding deadbolt 40 is configured for lateral translation in the direction shown by arrow A in FIG. 2.

In FIG. 2 the sliding deadbolt 40 is shown in the thrown position with an end of the sliding deadbolt positioned in the aperture of the drive member 30 thereby blocking movement of the drive member 30 and also preventing rotation of rotor and movement of bolt 11. Hence, in this position it will not be possible to turn the handle to drive the rotor 20 and the door or leaf is secured locked. The sliding deadbolt 40 may be retracted by a tang 52 of the key cylinder 50. On insertion of a matching key into the key cylinder 50, the barrel of the key cylinder may be turned. Clockwise rotation of the key (based on the orientation shown in the figure) will rotate the tang 52 of the key cylinder. The tang 52 will push against sidearm 42 of the sliding deadbolt 40 to retract the sliding deadbolt from the aperture 32 in the internal bolt 30. Further rotation of the key in the key cylinder will cause the tang 52 to move past the side arm and the key may be rotated a full circle and be removed from the key cylinder. The bolting mechanism in FIG. 2 further comprises a solenoid 60. In an alternative to moving the sliding deadbolt by the tang 52, the sliding deadbolt 40 may be driven by solenoid 60. A solenoid has a core which is moved to extend from, or retract into, the solenoid body depending on whether an electrical voltage or power is applied or turned off. Solenoids can be provided with alternative configurations such that they either require power to move the core into the extended position or require power to retract the core into the solenoid body. In the first configuration the solenoid shown in FIG. 2 is unpowered. On application of power the core 62 of the solenoid is retracted into the solenoid body. The retraction of the core 62 retracts the sliding deadbolt 40 from the aperture 32 releasing the internal bolt 30 for movement. In the alternative configuration, the solenoid in FIG. 2 is fitted in the reverse orientation so when powered the tail end of the core is thrown and turning off the power causes the core tail to retract into the solenoid. This movement of the core retracts the sliding deadbolt and releases the drive member 30. Hence, whether by rotation of the key in the key cylinder 50 or retraction of the core 62 into the solenoid 60 the drive member 30 and rotor 20 are released and the bolt 11 may be retracted.

For a multi-point bolting mechanism the drive member 30 may be extended to form a vertically upward moving bolt. When rotor 20 is driven by a handle (not shown) the drive member 30 translates vertically upwards driving a bolt upwards such as for securing the top of the door. Similarly, another rotor may be provided engaging with teeth (not shown) in the lower side of bolt 11 and driving a downwardly moving drive member. This rotor and downwardly moving drive member is largely a mirror image of the rotor 20 and drive member 30.

A problem with the bolting mechanism of FIGS. 1 and 2 is that in some circumstances it is desirable to rapidly throw the bolt or bolts to secure the door. In other circumstances it may be desirable to have a daytime mode in which the door is unsecured allowing free access unless a lockdown mode is activated in which the bolts are rapidly thrown. Accordingly, it is desirable to provide a bolting mechanism that provides at least some of this functionality.

### SUMMARY OF THE INVENTION

The present invention provides a bolting mechanism comprising a button for rapid release of bolts or priming of bolts for throwing as may be required in a lockdown mode. The bolting mechanism comprises at least one bolt, which may be known as a siege bolt, the at least one bolt moveable between a thrown position and a retracted position, the thrown position for securing a door; at least one first rotor arranged to simultaneously drive the at least one bolt and one or more drive members; a first bias arranged to drive the at least one first rotor to urge the at least one bolt to the thrown position; and a lockdown assembly comprising a lockdown button and plunger, the plunger movable between a blocking position and a retracted position, wherein the plunger is biased by a second bias to engage with one of the drive members and block throwing of the at least one bolt, and the lockdown button is arranged to release the plunger such that the first bias primes the drive member and the at least one bolt ready to be urged to the thrown position. Accordingly, pushing the lockdown button rapidly throws the bolts or primes them ready to be thrown as soon as the door closes.

Preferably, the second bias is weaker than the first bias such that the first bias is arranged to drive the at least one bolt and push the plunger to a retracted position.

The plunger may comprise a ball and pushrod or rod, and the one of the drive members comprises a recess arranged to receive at least part of the ball to block throwing of the at least one bolt.

The lockdown button may comprise a stem, the stem may have a foot arranged to block retraction of the plunger when the plunger is in the blocking position and until the button is pressed.

The lockdown assembly may further comprise a button reset plate and the lockdown button may comprise a heel, the button reset plate arranged such that when the button is pressed the button reset plate catches against the heel to hold the lockdown button in the pressed position.

The heel and button reset plate may be arranged to move transversely to each other. The heel and button reset plate may have wedge surfaces arranged such that pushing of the lockdown button causes the wedge of the heel to move past the wedge of the button reset plate to latch or catch the lockdown button in the pressed position.

The bolting mechanism may further comprise an indicator lever coupled to the button reset plate. The indicator lever may have a first end or free end that moves as the button reset plate moves. The first end or free end of the indicator lever may be arranged to show an amount of movement that is greater than the amount of movement of the button reset plate. Accordingly, the indicator lever may be considered to magnify the amount of movement of the button reset plate. The first end or free end may be visible through a lockdown status indicator window of a casing of the bolting mechanism.

The indicator lever may be arranged to indicate two or more positions of the button reset plate, the two or more position indicating two or more of: i) the at least one bolt is retracted; ii) the lockdown button has been pressed and the at least one bolt is primed to throw; and iii) the at least one bolt is thrown.

The one of the drive members, that is engaged by the plunger, may comprise a release tab or plate. The release tab or plate may be arranged such that when the at least one bolt moves to the thrown position the release tab or plate pushes the button release plate to release the lockdown button.

The bolting mechanism may further comprise a bolt status indicator window. The one of the drive members may comprise first and second indicator portions, such as of different colours or symbols. The indicator portions may be arranged on the one of the drive members such that when the at least one bolt is in the thrown position the first indicator portion is visible through the bolt status indicator window and when the at least one bolt is in the retracted position the second indicator portion is visible through the bolt status indicator window. The indicator status window may be provided in a casing of the bolting mechanism.

The release tab or plate may comprise the first and second indicator portions.

Together the indicators may provide visual awareness of the different lock and hold-back status positions, including: a daytime latching mode, which may be indicated by the second indicator portion which may be coloured green; a lockdown activated mode with security bolts thrown, which may be indicated by the first indicator portion which may be coloured red; and a lockdown primed mode with the door open waiting for bolt(s) to fire, which may be indicated by the position of the free end of the indicator lever which may be coloured orange or amber.

The one of the drive members may comprise a recess arranged to receive the button reset plate when the one or more bolts are in the retracted position.

The bolting mechanism may further comprise a deadbolt assembly comprising a deadbolt movable between an extended position and a retracted position, wherein in the extended position the deadbolt extends into a first notch in the one or another of the one or more drive members to block retraction or alternatively throwing of the at least one bolt. The first notch may be a notch with square or transverse sides, for example, such that the deadbolt cannot be pushed back. The deadbolt may be retracted by a key cylinder or an access control operated solenoid to allow free entry. When the deadbolt is thrown access free egress remains possible for life-safety.

The bolting mechanism may further comprise a latch assembly comprising an independently sprung latch bolt. In more detail the latch assembly may comprise: a latch bolt; and a latch rotor assembly comprising one or more second rotors, wherein the latch bolt is biased to a thrown position and one of the one or more second rotors is configured to be rotated to retract the latch bolt. The one of the one or more second rotors may be further arranged to drive the one or another of the one or more drive members to retract the at least one bolt. The one of the one or more second rotors may be arranged to be rotated by a handle or key cylinder. For example, a handle on the inside of the door or a key cylinder on the inside or outside of the door.

The one of the one or more second rotors may be an inside second rotor arranged to be driven by a handle (or key cylinder) on the inside of a door. The latch assembly may further comprise: an inside latch slider arranged to be driven by the inside second rotor to retract the latch bolt; a drive member inside slider arranged to be driven by the inside second rotor to move the drive member, such as a driver member locked by the deadbolt, to retract the at least one bolt. Accordingly, the handle (or key cylinder) on the inside of the door may drive retraction of both deadbolt and the latch. There may be lost motion between the inside latch slider and latch bolt, and also between the drive member inside slider and the one of the drive members.

The drive member inside slider may comprise a notch to receive the deadbolt. The notch may have a ramp surface, such as on the lower side of notch or side of the notch further from the deadbolt, such that when the drive member is driven by the inside second rotor the ramp surface pushes against the deadbolt to move the deadbolt to the retracted position.

The latch rotor assembly may further comprise: an outside second rotor arranged to be driven by a handle or key cylinder on the outside of the door, and the latch assembly may further comprise: an outside latch slider arranged to be driven by the outside second rotor to retract the latch bolt; a drive member outside slider arranged to be driven by the outside second rotor to move the drive member, such as the drive member into which the deadbolt is thrown, to retract the at least one bolt. The drive member outside slider may comprise a notch into which the deadbolt extends, the notch having square sides blocking retraction of the at least one bolt. Hence, rotation of the external handle may be blocked by the deadbolt preventing access from the outside.

The drive member, such as the drive member into which the bolt is thrown, may comprise a second notch for receiving the deadbolt, the second notch may have a ramp surface to override the deadbolt when the at least one bolt is moving to the thrown position.

Lost motion in the driving of the latch bolt and drive member allows the latch to be operated independently of the other bolt(s).

The deadbolt assembly may comprise a solenoid arranged to move the deadbolt between retracted and thrown positions.

The bolting mechanism may further comprise a sensor, such as an electronic sensor, configured to monitor whether the at least one bolt is in the thrown position or the retracted position. The bolting mechanism may be configured such that: if the sensor detects that the at least one bolt is in the thrown position, the solenoid is disabled; and/or if the sensor detects that the at least one bolt is in the retracted position, the solenoid is disabled. The function of disabling the solenoid may by a switch opening or closing or may be controlled by a controller receiving a signal from the sensor. The monitoring of the bolt status, that is the siege bolt status, may be used to isolate deadbolt solenoid and so turn-off access control, when the at least one bolt is thrown and/or retracted, depending on desired functionality.

The deadbolt assembly may comprise: a key cylinder, the key cylinder having a cam rotatable on insertion of a matching key. The cam may be arranged such that on rotation the cam pushes against a protrusion on the deadbolt to retract and throw the deadbolt. The deadbolt assembly may further comprise a switch arranged to be operated as the cam is rotated, wherein one of pressing or releasing the switch disables the solenoid and the other of pressing or releasing the switch enables the solenoid.

The deadbolt assembly may comprise: a rotational slider arranged to move along an arc when pushed by the cam of the key cylinder; and a sprung plunger biased to respectively move into first and second recesses in the rotational slider depending on the rotational position of the rotational slider, the first recess being deeper than the second. The deadbolt assembly may be configured such that on rotation of the cam to a first position the sprung plunger extends into the first recess and the switch is released, and the on rotation of the cam to a second position the sprung plunger extends into the second recess and the switch is pressed.

The at least one bolt may comprise a first laterally movable bolt for securing the side of a door.

The bolting mechanism may further comprise: a first vertically movable bolt configured to move vertically upwards for securing the top of a door and driven by one of the one or more drive members; and/or a second vertically movable bolt configured to move vertically downwards for securing the bottom of a door and driven by another of the one or more drive members.

The bolting mechanism may further comprise a bolt restraint for restricting throwing of the first or second vertically movable bolt until the door is closed. The bolt restraint may comprise an actuator arranged to be pushed against a door frame as the door is closed releasing the bolt for throwing.

As well as, or instead of, vertically movable bolts, the bolting mechanism may comprise: a second laterally moveable bolt for securing the side of a door, the second laterally movable bolt spaced downwards from the first laterally movable bolt, the second laterally movable bolt arranged to be driven by a first auxiliary bolt driver driven by one of the one or more drive members; and/or a third laterally moveable bolt for securing the side of a door, the third laterally movable bolt spaced upwards from the first laterally movable bolt, the third laterally movable bolt arranged to be driven by a second auxiliary bolt driver arranged to be driven by another of the one or more drive members.

The present invention further provides a bolting mechanism with an alternative lockdown mode which, on wanting to open the door, would require the lockdown button is pressed first to prime release of the bolts which would then be released on turning of a handle or key cylinder. In such an embodiment, the bolting mechanism comprises: at least one bolt, the at least one bolt moveable between a thrown position and a retracted position, the thrown position for securing a door; at least one first rotor arranged to simultaneously drive the at least one bolt and one or more drive members; a first bias arranged to drive the at least one first rotor to urge the at least one bolt to the thrown position; and a lockdown assembly comprising a lockdown button and plunger, the plunger movable between a blocking position and a retracted position, wherein the plunger is biased by a second bias to engage with one of the drive members and block retracting of the at least one bolt, and the lockdown button is arranged to release the plunger such that the at least one bolt is ready to be moved to the retracted position on action of a handle or key cylinder driving the at least one first rotor.

The present invention also provides a bolting mechanism with a hold-back mode, the bolting mechanism comprising: at least one bolt, the at least one bolt moveable between a thrown position and a retracted position, the thrown position for securing a door; at least one first rotor arranged to simultaneously drive the at least one bolt and one or more drive members; a first bias arranged to drive the at least one first rotor to urge the at least one bolt to the thrown position; and a hold-back assembly comprising a hold-back plunger, the hold-back plunger movable between a blocking position and a retracted position, wherein the hold-back plunger is biased by a second bias to engage with one of the drive members and block throwing of the at least one bolt, and a key cylinder arranged to retract the hold-back plunger and release the at least one bolt to move, or ready to be moved, to the thrown position.

There is further provided a bolting mechanism comprising: at least one bolt, the at least one bolt moveable between a thrown position and a retracted position, the thrown position for securing a door; at least one first rotor arranged to simultaneously drive the at least one bolt and one or more drive members; a first bias arranged to drive the at least one first rotor to urge the at least one bolt to the thrown position; and a bolt-restraint plunger, the bolt-restraint plunger movable between a blocking position and a retracted position, wherein the bolt-restraint plunger is biased by a second bias to engage with one of the drive members and block throwing and/or retracting of the at least one bolt, and a release driver arranged to retract the bolt-restraint plunger and release the at least one bolt to move, or ready to be moved, to the thrown or retracted position. The release drive may be a push button, key-cylinder, turn-knob etc.

The present invention further provides a bolting mechanism with latch, the bolting mechanism comprising: at least one bolt, the at least one bolt moveable between a thrown position and a retracted position, the thrown position for securing a door; at least one first rotor arranged to simultaneously drive the at least one bolt and one or more drive members; a bias arranged to drive the at least one first rotor to urge the at least one bolt to the thrown position; a latch assembly comprising a latch bolt and a second rotor, the latch bolt biased to a thrown position and the second rotor configured to be rotated by a handle to retract the latch bolt, the second rotor further arranged to drive the at least one drive member to retract the at least one bolt. The latch bolt may be independently sprung.

Embodiments of the present invention may also provide a door or leaf comprising any of the bolting mechanisms described herein.

### BRIEF DESCRIPTION OF THE DRAWINGS

Embodiments of the present invention, and aspects of the prior art, will now be described with reference to the accompanying drawings, of which:

FIG. 1 is a diagram of a door having a multi-point bolting mechanism for securing the door, according to the prior art;

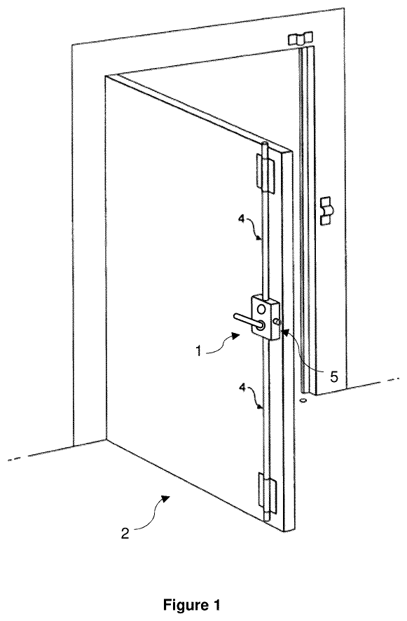

FIG. 2 is a plan view showing bolting mechanism similar that of FIG. 1 but having a single bolt.

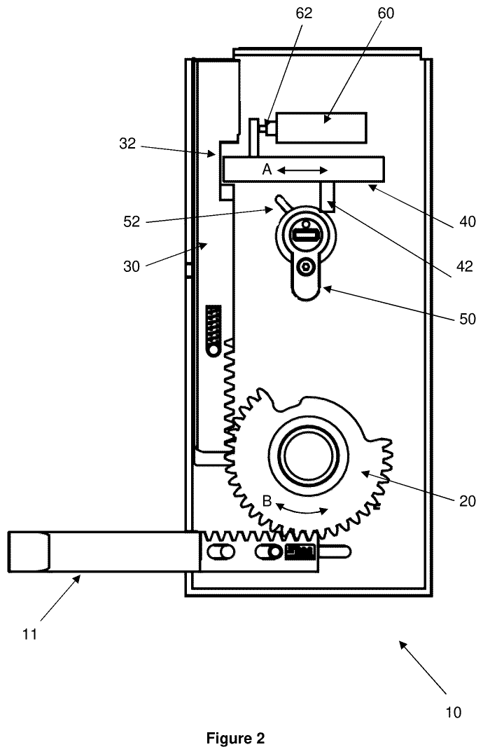

FIGS. 3A and 3B are perspective drawings showing a multi-point bolting mechanism with lockdown button and latch bolt according to the present invention, with FIG. 3A showing the bolts thrown, FIG. 3B showing the bolts retracted and FIG. 3C being a close-up view of a bolt-restraint;

FIGS. 4A and 4B are plan views of the bolting mechanism at different points of operation as viewed from an inside side of a door, with FIG. 4A showing the bolts and latch bolt thrown and the deadbolt thrown blocking retraction of the bolts;

FIGS. 5A and 5B are plan views of the bolting mechanism of FIGS. 4A and 4B at further different points of operation as viewed from an inside side of a door, with FIG. 5A showing the bolts retracted and held in place by the deadbolt and the latch bolt thrown and FIG. 5B also having the latch bolts depressed;

FIG. 6 is a plan view of the bolting mechanism of FIGS. 4A and 4B as viewed from an outside side of a door, with FIG. 6 showing the bolts and latch bolt thrown, the bolts held in place by the deadbolt, and the button reset plate pushed back;

FIGS. 7A and 7B are plan views of the bolting mechanism of FIGS. 4A and 4B as viewed from an outside side of a door, with FIG. 7A showing the bolts retracted and latch bolt thrown, similar to FIG. 5A, and FIG. 7B showing the bolts retracted having been retracted by an external handle;

FIGS. 8A-8D are cross-sectional views through the lockdown button assembly showing different states of operation;

FIGS. 9A-9C are plan views of the lockdown button assembly showing indicators for identifying the status of the bolts and lockdown button;

FIG. 10 is a perspective view of the latch bolt assembly;

FIGS. 11A-11C are plan views of the deadbolt assembly including a key cylinder and switch for activating and deactivating a solenoid, at three states of operation; and

FIGS. 12A-12D are plan views of the deadbolt assembly of FIGS. 11A-11C, with FIG. 12C being a close-up view of FIGS. 11A and 12A and FIG. 12D being a close-up view of FIGS. 11B and 12B.

### DETAILED DESCRIPTION

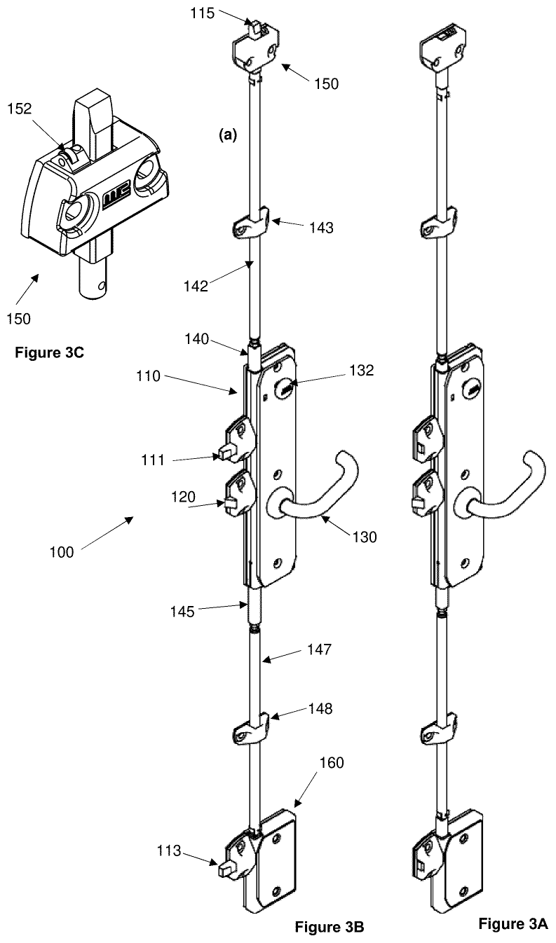

FIGS. 3A and 3B are perspective views of a multipoint bolting system 100 according to embodiments of the present invention. FIG. 3A shows the bolts in the thrown position for securing a door and FIG. 3B shows the bolts in the retracted position. FIG. 3C is a perspective view of a bolt restraint 150 for restraining a bolt from being thrown until the door is closed, as shown from the rear compared to FIG. 3A. We now describe in more detail FIGS. 3A-3C.

In FIGS. 3A and 3B there is shown multipoint bolting system 100. The bolting system 100 comprises bolting mechanism 110 which is configured for driving bolts 111, 113, 115. Bolt 111 is driven laterally to secure an opening side of the door. Bolt 115 is driven vertically upwards to secure the top of the door. Bolt 115 is located spaced apart from casing of bolting mechanism 110 because handle 130 and central part of the bolting mechanism will likely be located at mid-height around half way up the door. Drive member 140 includes auxiliary drive member 142 to move bolt 115 upwards. The auxiliary drive member 142 is constrained by guide 143 and bolt restraint 150. Bolt restraint 150 stops the bolts being thrown unless the door is closed. A trigger 152 extends from the bolt restraint. When the door closes, the trigger is pushed in by the door frame. The pushing of the trigger releases the bolt restraint allowing the bolts to be thrown. An example of such a bolt restraint is described in UK Patent Application by the current applicant and published as GB 2622614, which is incorporated by reference in its entirety to the extent possible.

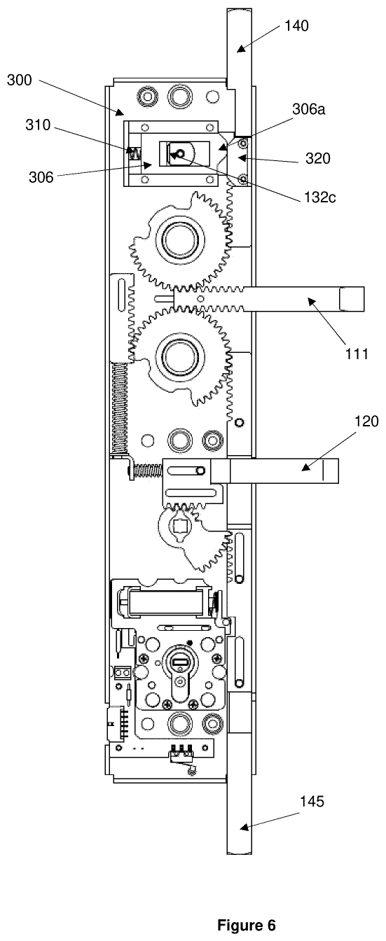

At the bottom of FIG. 3A is shown bottom bolt 113 which is arranged to move laterally, differently to top bolt 115. Drive member 145 is driven by bolting mechanism 110 which drives auxiliary drive member 147 constrained by guide 148. Auxiliary drive member 147 in turn drives auxiliary drive unit 160. Auxiliary drive member may have teeth which mesh with teeth of a rotor in auxiliary drive unit 160 such that the downward movement of the auxiliary drive member 147 is converted to the lateral motion of throwing the bolt 113. FIG. 3A also shows lockdown button 132 for emergency throwing of bolts, which we will describe later with reference to FIGS. 6 to 8.

FIG. 3B shows the same arrangement as FIG. 3A but the three bolts are shown retracted.

In alternative arrangements the bolting system may comprise a downward moving bolt instead of bolt 113. Such a downward moving bolt would simply be connected to drive member 145 or auxiliary drive member 147 and directed downward. The upwardly moving bolt 115 is thrown when the bolt restraint 150 releases the bolt when the door closes. As all the bolts move together, the bolt restraint 150 also prevents the downwardly moving bottom from being thrown thereby stopping it dragging on the floor until released when the door closes.

In a further alternative arrangement the bolting system may comprise three laterally moving bolts for securing the opening side of the door. The three such bolts are bolts 111 and 113 shown in FIG. 3. Top bolt 115 is replaced by a laterally moving bolt similar to 113 but driven by auxiliary drive member 142 from the top of the bolting mechanism 110. Such an arrangement would include an auxiliary drive unit similar to auxiliary drive unit 160 for converting the upwards vertical movement of auxiliary drive member 142 into lateral motion.

In yet a further alternative embodiment the bolting system may comprise only one bolt or only two bolts. For example, if one bolt is provided it may be the lateral bolt 111 which is driven directly out of bolting mechanism 110. If two bolts are provided they may be lateral bolt 111 and an upper or lower vertically moving bolt or laterally moving bolt.

Also shown in FIGS. 3A and 3B is a latch bolt 120 which is driven by handle 130. The latch bolt may act to maintain a door closed whether or not the bolts are thrown and may be retracted to open the door by turning handle 130.

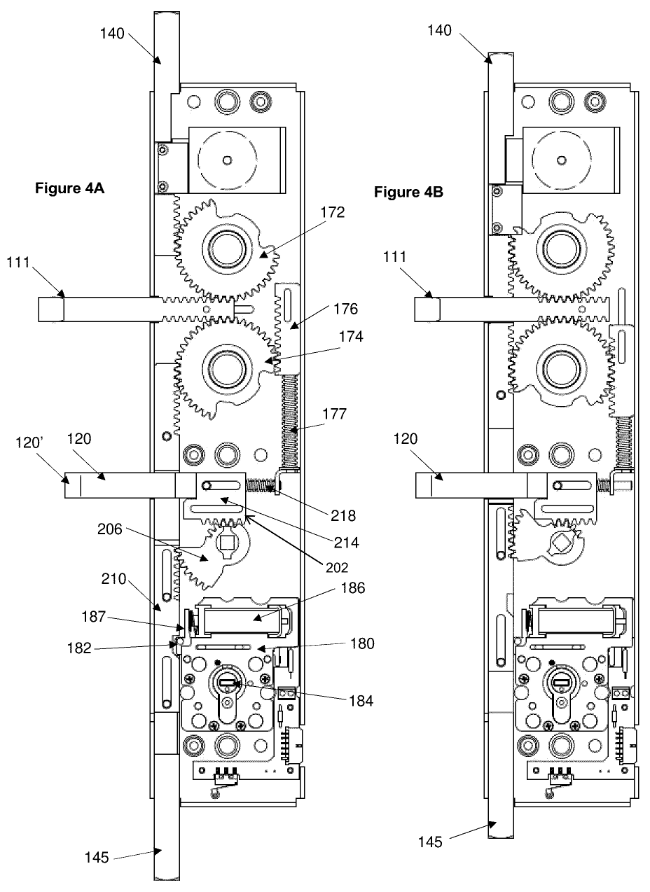

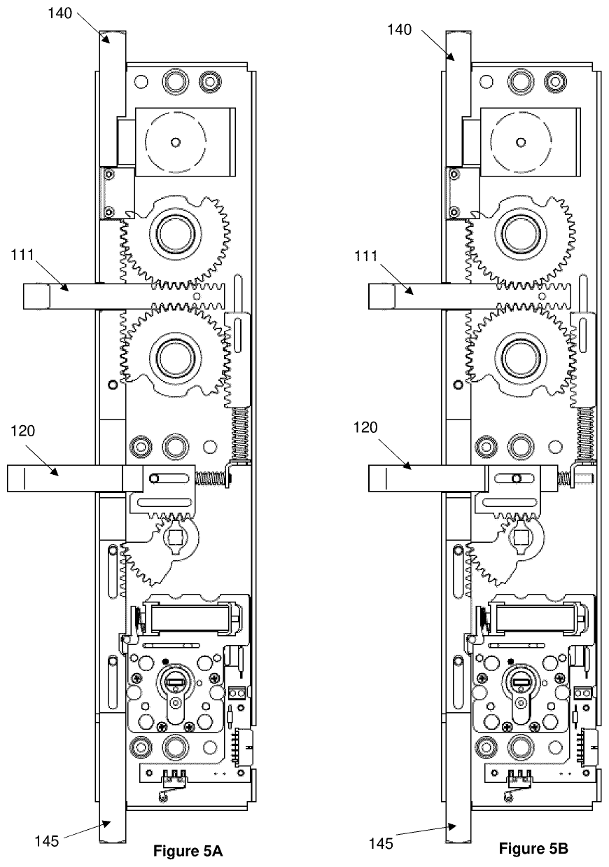

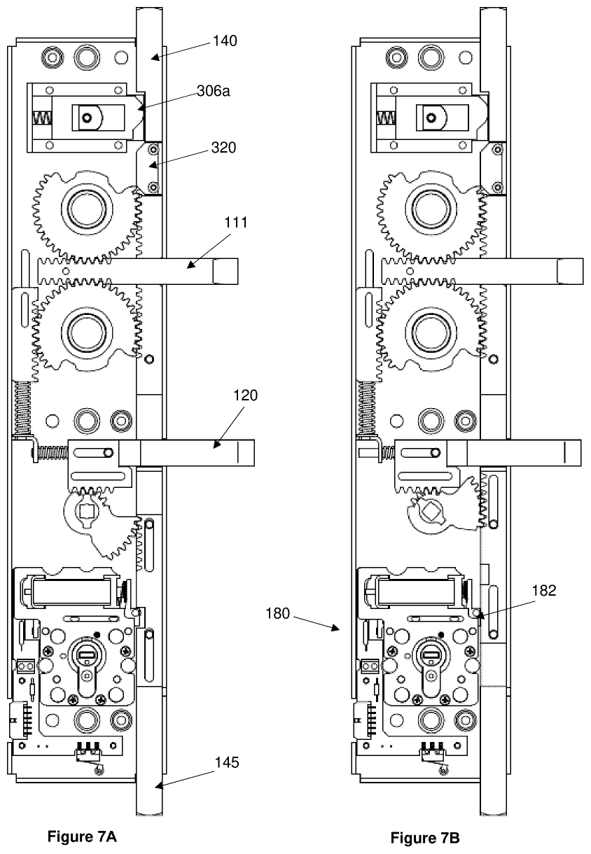

FIGS. 4 and 5 are internal plan views of the bolting mechanism 110 of FIGS. 3A and 3B. FIGS. 4 and 5 show the bolting mechanism at different states of operation as viewed from an inside side of a door. FIGS. 6 and 7 show the bolting mechanism at different states of operation but instead viewed from an outside side of the door. The security requirements for opening a door from the outside are stricter than from the inside.

As shown in FIG. 4A the bolting mechanism comprises bolt 111 which is driven by rotors 172 and 174 which engage with teeth of the bolt 111. The rotor 172 is arranged above the bolt with teeth meshing with teeth of a rack on an upper side of the bolt 111. The rotor 174 is arranged below the bolt with teeth meshing with teeth of a rack on a lower side of the bolt 111. One or other of the rotors may be driven by a handle (not shown). For example, handle 174 may comprise an aperture at its axis for receiving a spindle to be driven by a handle. Rotation of the handle clockwise will rotate rotor 174 clockwise retracting the bolt. To return the bolt 111 to the thrown position, a bias member 176 is provided which has a rack having teeth engaging with rotor 174. Bias member 176 is biased by spring 177 to be urged upwards thereby rotating rotor 174 anticlockwise to throw the bolt 111. Rotation of rotors 172 and 174 also drives drive members 140 and 145. Upper rotor 172 has teeth meshing with a rack on drive member 140 such that when rotor 172 is rotated clockwise to throw bolt 111, rotor 172 also drives drive member 140 upwards to throw a bolt such as bolt 115 attached thereto. Lower rotor 174 has teeth meshing with a rack on drive member 145 such that when rotor 174 is rotated anticlockwise to throw bolt 111, rotor 174 also drives drive member 145 downwards to throw a bolt attached thereto or drives a bolt 113 from auxiliary drive unit 160.

The bolting mechanism further comprises a deadbolt assembly 180 comprising a deadbolt 182 which is arranged to be thrown into a notch or recess in drive member 145 and retracted from the drive member. The deadbolt 182 is arranged to be thrown and retracted by key cylinder 184 and solenoid 186. On insertion of a matching key into key cylinder 184 a cam of the key cylinder can be rotated. The cam pushes against a protrusion on the deadbolt to thrown and retract the deadbolt depending on the direction of rotation of the key. The solenoid 186 is also arranged to throw and retract the bolt. In one embodiment, when power is supplied to the solenoid, a core of the solenoid is moved towards the drive member 145 pushing against actuator 187 driving the deadbolt into the notch or recess of drive member 145. The core may be biased by a spring such that on removing power from the solenoid the spring retracts the core thereby retracting the deadbolt. In an alternative embodiment, the functions of the spring bias and power on the solenoid are reversed. In this case, when power is not supplied to the solenoid, the spring bias pushes the core of the solenoid towards the drive member 145 pushing against actuator 187 driving the deadbolt into the notch or recess of drive member 145. When power is supplied, the core may be driven back thereby retracting the deadbolt.

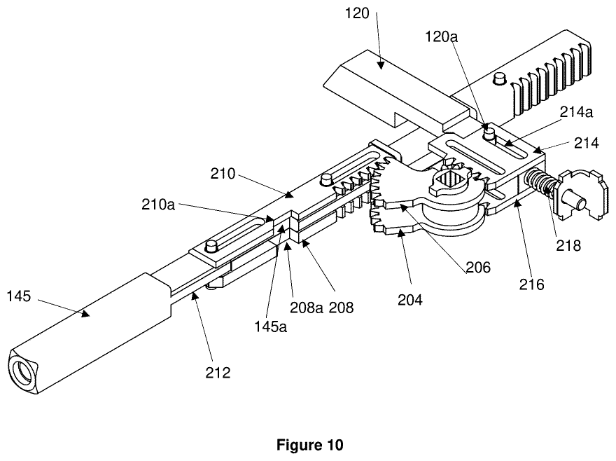

Also shown in FIG. 4 is a latch bolt 120 which is shown in more detail in FIG. 10. FIG. 10 is a perspective view of the latch bolt assembly 202. Referring to FIGS. 4 and 10 the latch bolt assembly comprises latch bolt 120 which is biased to the thrown position by spring 218. The latch bolt itself comprises a chamfered, wedge-shaped or curved end-face 120′. Latch bolt is generally urged to the thrown position but on closing of a door, the latch bolt will push against a door frame or strike plate pushing the latch bolt inwards to a retracted position. The shape of the end face allows the latch bolt to be pushed in by the door frame or strike plate in this way. Once the door is fully closed the latch bolt 120 is urged to the thrown position and extends into a keeper hole in the frame strike plate so as to hold the door closed. As shown in FIG. 4 the latch bolt assembly further comprises inside latch rotor 206 which engages with sliding racks on the latch bolt and on the drive member 145. The inside latch rotor 206 has teeth at different radii for meshing with the inside latch slider 214 that slides on the latch and for meshing with the drive member inside slider 210 that slides on the drive member 145. The teeth of the inside latch rotor that mesh with the drive member inside slider are at a greater radius than that meshing with the inside latch slider. The differences in radii are to achieve different amounts of lateral movement of the latch bolt compared to the drive member 145. FIG. 3 shows a handle 130 that is coupled to the inside latch rotor 206. The handle is coupled to the bolting mechanism on the inside or indoor side of a door. On rotation of the handle the latch rotor rotates pulling back (to the right in the figure) the inside latch slider 214 which pulls back the latch bolt 120. The inside latch slider has a slot 214 in which a pin or protrusion 120a from the latch bolt protrudes. As shown in the figures with the pin at the left hand end of the slot, when the inside latch slider 214 is pulled to the right the pin is at the end of the slot and is also pulled to the right retracting the latch bolt 120. Accordingly, by turning handle 130 the latch bolt is retracted and the door may be opened. On closing the door without turning the handle the latch bolt will hit the door frame or strike plate and be pushed in or depressed. When this happens the pin 120a moves along slot 214a without turning the handle. Not visible in FIG. 4 but visible in FIG. 10 is that the latch bolt assembly 202 may further comprise an outside latch slider 216, an outside latch rotor 204 and a drive member outside slider 208. By providing an inside latch rotor and an outside latch rotor the latch bolt may be independently driven from either side of the door without rotating the handle on the other side of the door.

Drive member inside slider 210 and drive member outside slider are used to control how operation of the latch bolt interacts with driving the driving member 145 and consequently the bolt or bolts such as 111, 113 and 115. Both drive member sliders 208, 210, are constrained to move along the drive member 145 by having slots into which pegs or pins from bolt locate. This means the drive member sliders are constrained to move longitudinally along the drive member 145. The drive member sliders are configured to move independently of each other. Both drive member sliders have a notch or recess 208a, 210a, to allow them to interact with deadbolt 182. As previously mentioned, deadbolt 182 blocks retraction of the drive member 145 when the deadbolt is thrown into notch or recess indicated by 145a in FIG. 10. The notch or recess 145a of the drive member 145 and the notch or recess 208a of the drive member outside slider 208 both have square sides. That is, the sides are transverse or perpendicular to the direction of movement of the drive member. This means that when the deadbolt is thrown, movement of the drive member 145 and the drive member outside slider 208 are blocked. For the drive member inside slider 210 the notch or recess 210a has one side that has a ramp or angled surface. This is the side that is furthest from the centre of the bolting mechanism. When handle 130 is rotated on the inside of the door the inside latch rotor 206 rotates clockwise (based on the view shown in FIGS. 4 and 10) which acts to move drive member inside slider 210 upwards. As the drive member inside slider moves upwards the ramp surface of notch or recess 210 pushes against the end of the deadbolt moving the deadbolt out of its path. Hence, rotation of inside rotor may retract both the latch bolt, the drive member and bolt or bolts 111, 113, 115.

We now describe the different positions of operation of the deadlock mechanism as shown by FIGS. 4, 5, 6, and 7. In FIG. 4A the bolt 111 and drive members 140, 145, (which may connect to, and drive, bolts 113, 115) are shown in their thrown positions. The latch bolt 129 is also thrown. Deadbolt 182 is also thrown blocking retraction of the bolts such as by pushing or applying force to the ends of the bolts. In FIG. 4B and as described above, the latch bolt 120, bolt 111 and drive members 140, 145, have all been retracted by turning handle 130 on the inside of the door. The drive member inside slider 210 has pushed back the deadbolt 182. In FIG. 5A the handle 130 has been released and the inside latch rotor has returned to its rest position also shown in FIG. 4A. However, the bolt 111 and drive members 140 and 145 are held in the retracted positions. The drive member comprises a second notch or recess (not shown in the figures) further down the drive member 145 such that when the drive member is retracted it can be locked in the retracted position by throwing the deadbolt. For example, the deadbolt may be thrown by turning key cylinder or by action of the solenoid such as activated by an access control system. In this configuration the bolting assembly operates to secure the door only on the latch bolt. This may be considered to be a daytime mode in which persons are able to leave the building by turning the handle. In FIG. 5B the bolt 111 and drive members 140, 145, remain retracted and here the latch bolt 120 is depressed such as may occur when the door is being closed and the latch bolt is depressed as it hits the strike plate or door frame. Free entry by turning the handle is also available when daytime mode is activated.

In relation to FIGS. 4 to 6 at least, we describe two rotors 172, 174, being used to transfer motion between drive members 140, 145 and bolt 111. In alternative embodiments, in which there is no requirement for a bolt to be deployed on a door higher up than the lateral bolt 111, upper rotor 172 may not be included. Alternatively, if no lower bolt is required, the unit may be reversed and no lower rotor 174 is included. In such cases only one drive member may be included and the various functions applied to the drive members are aggregated on to the single drive member. For example, if a bolt is not required for securing the top of the door, the upper drive member 140 and upper rotor 172 may be omitted. In such a case, lockdown assembly 300 comprising lockdown button 132 would be moved to interact with the lower drive member 145.

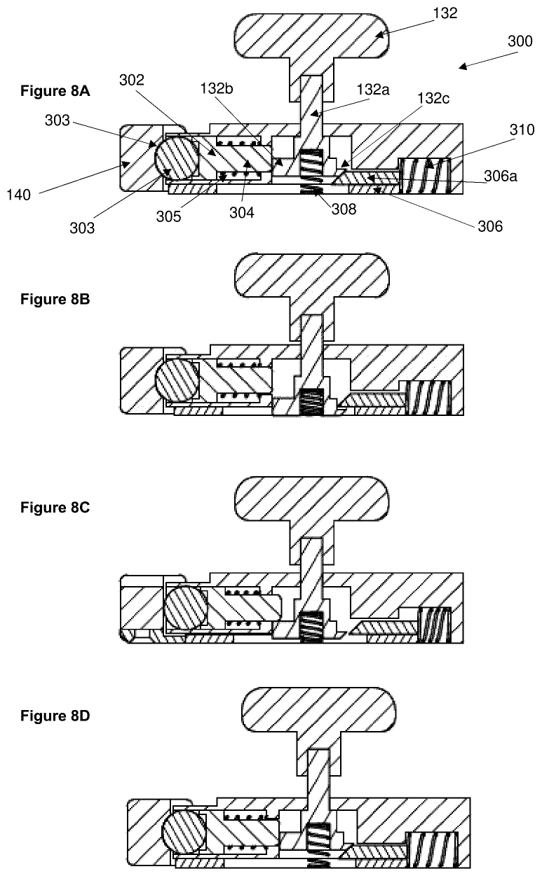

FIG. 6 shows the latch bolt 111 thrown, bolt 120 thrown and drive members 140, 145 also thrown or extended. This in the same way as shown in FIG. 5A but in FIG. 6 it is viewed from the outside side of the door or bolting mechanism. From this view more detail of the lockdown assembly 300 can be seen. The lockdown assembly is also shown in FIGS. 8A-8D in cross-section.

In FIG. 8A the lockdown button is shown as a mushroom shaped button to be pushed with a stem 132a. Other shapes of button may be used. As the lock down button is for rapid throwing of bolts such as in an emergency situation, the lockdown button should be highly visible such as a red colour. The lockdown assembly also comprises a plunger 302 which may consist of a pushrod 304 and ball or ball bearing 303. The ball bearing is arranged to be held in a cup-like arrangement at the end of the pushrod. Spring 305 biases plunger 302 towards drive member 140. When the drive member is at the correct position, the ball-bearing of plunger is pushed into a recess in the drive member 140 blocking movement of the drive member. As mentioned previously, the drive member 140 may also extend and form a bolt. Spring 308 biases the lockdown button outwards ready to be depressed. At the base of the stem 132a of lockdown button 132 is a foot 132b which extends laterally from the stem towards plunger 302. At the other side of the stem 132a is a heel 132c which has a ramp or wedge surface. Shown at the bottom of FIG. 8A and also towards the top of FIG. 6 is button reset plate 306. Spring 310 biases button reset plate 306 towards drive member 140. Button reset plate 306 may take many different shapes but is shown in FIG. 6 as generally rectangular with an extension face 306a towards the drive member 140. The button reset plate has an aperture through which spring 308 extends to a case or housing surface. Button reset plate 306 also comprises a ramp or wedge surface. The wedge surfaces of the button reset plate and heel push against each other.

Returning to FIG. 6 we mentioned that the configuration shown has latch bolt 111 thrown, bolt 120 thrown and drive members 140, 145 also thrown or extended. In FIG. 7A the bolt 111 has been retracted as have drive members 140 and 145, but the latch bolt 120 remains thrown. In FIG. 7B the bolt 111, drive members 140 and 145, and the latch bolt 120 have all been retracted by turning an external handle. This is possible because the deadbolt of deadbolt assembly has been retracted by key cylinder or solenoid.

As described previously, FIG. 8A shows the lockdown button in the extended or ready to be pushed position. The plunger 302 is extended into the recess in the drive member 140 blocking movement of the drive member 140. The ramp or wedge surfaces of the heel of the button and the reset plate are in contact with each other. These ramp surfaces may be at around 45° to the direction of movement of the button reset plate. The reset plate is biased towards the drive member. The bolt and drive members are retracted and held retracted by the ball bearing of the plunger. If it is attempted to throw the bolt and drive members it is blocked by the plunger. In turn, movement of the plunger 302 is blocked by the distal end of the plunger abutting the foot 132b of lockdown button 132. In FIG. 8B the lockdown button 132 has been pressed. The foot 132b has moved clear of the plunger 302. The bolts and drive member are not yet thrown because they may be held retracted by a bolt restraint until the door is closed. The wedge surface of the heel of the lockdown button has pushed past the wedge surface of the button reset plate such that the back of the wedge surface holds the lockdown button in the depressed state against the action of spring 308. When the door closes the bolt and drive members are thrown as shown in FIG. 8C. With the bolt 111 now thrown the drive member 140 is also thrown. As shown in FIG. 7A before throwing, extension face 306a of reset plate was located in a recess or notch in the drive member. Now that the drive member is thrown, a release tab 320 on the drive member moves upwards, as shown in FIG. 6, pushing against extension face 306a of button reset plate pushing it back. This can also be seen in FIG. 8C where the wedge or ramp surfaces of the heel and button reset plate are clear of each other. FIG. 8D shows that the bolt and drive members are again in the retracted position, the spring 305 has pushed the plunger into the recess of the drive member 140, and the lockdown button 132 is reset ready to be pushed again. The release tab 320 has ramp surfaces a shown in FIG. 6 to ease pushing back of the button reset plate.

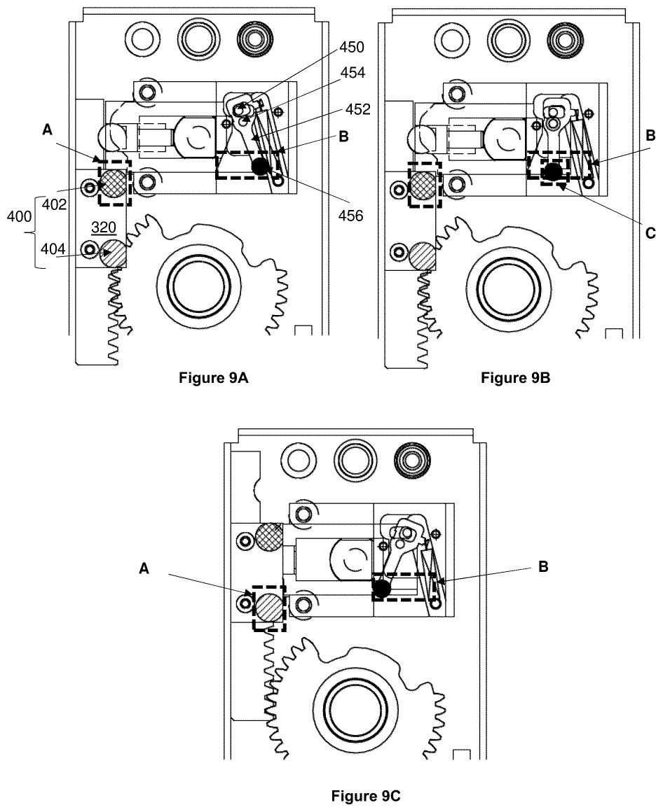

When the bolts are stopped from being thrown by bolt restraints but the lockdown button has been pressed, the door and bolting system may appear the same as when the bolts are held retracted by the bolting mechanism. Hence, it is useful to provide one or more indicators to a user regarding the status of the bolting mechanism. FIGS. 9A-9C illustrate two indicator systems. The first indicator 400 provides a visual indication of whether the bolt(s) and drive members are thrown or not. This is provided by visual indicators on release tab 320. A window in casing of the bolting mechanism is also provided. Different visual indicators may be provided. For example, a first colour such as red may be painted on a portion of the release tab that aligns with the window when the bolt and drive members are in the thrown position. A second colour such as green may be painted on a different portion of the release tab that aligns with the window when the bolt and drive members are thrown. As shown in FIG. 9A, two indicator portions 402 and 404 may be provided on release tab 320, although other positions on drive members may be used instead. In the figure a position corresponding to window for viewing the indicator is identified by the square labelled “A”. In FIG. 9A the bolt and drive members are retracted so first indicator shown by crossed shading is present in the window, whereas in FIG. 9C the bolt and drive members are thrown so second indicator shown by diagonal lines is present in the indicator window.

A second indicator may also provide an indication of whether the bolt and drive members are primed ready to be thrown but have not yet thrown such as because of a bolt restraint. As described in relation to FIGS. 8A-8D, there is movement of the button reset plate 306 from when the button is held ready to be pushed and when the bolt and drive members are thrown. The button reset plate 306 also has a slightly different position when the lockdown button is pressed but the bolts have not yet been thrown. This can be seen by comparing FIGS. 8A, 8B, and 8C. The movement amounts may be small so the second indicator magnifies the movement. The second indicator comprises a lever 452 that moves about pivot 454. Button reset plate 306 comprises a pin 450 which sits in a hole in the lever close to the pivot. The opposite end of the lever, further from the pivot than the hole, comprises a visual indicator 456 such as an orange painted circle or disc (shown as solid black circle in FIGS. 9A-9C). As the button reset plate 306 moves the visual indicator 456 moves a greater amount that is easily visible to the user. Window for viewing second visual indicator may allow all of the movement of the second visual indicator to be seen, such as indicated by rectangle “B”. Next to the window could be marked statuses of: “open”, “primed” and “locked” corresponding to the positions of the visual indicator 456. Alternatively, the window could be smaller such as rectangle “C” and arranged such that the visual indicator is only visible in window “C” when the lockdown button has been pressed, the bolt and drive members are primed ready to be thrown but have not yet thrown.

We have described that the lockdown assembly is reset by release tab 320 pushing back the button reset plate 306 as the bolt(s) 120 and drive members 140, 145, are retracted. In embodiments it may be desirable that reset can only be performed by authorised persons. In such an embodiment the release tab 320 is removed such that retraction of the bolts and drive members does not automatically reset the lockdown assembly. Instead a key cylinder driving a cam is included. The key cylinder and cam would be included mounted to or behind the lockdown assembly. The cam of the key cylinder is sized and position such that on turning of a matching key to the key cylinder the cam pushes against the button reset plate to retract it and reset the lockdown assembly. This may be achieved by the lobe of the cam sitting in a notch or recess in the button reset plate such that rotation of the moves the button reset plate backwards. Hence, only an authorised person having a key would be able to reset the lockdown assembly.

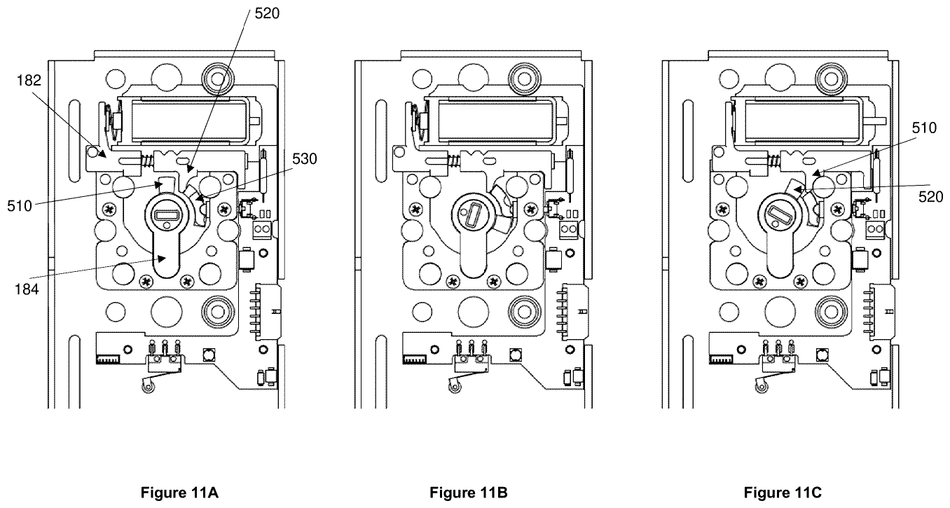

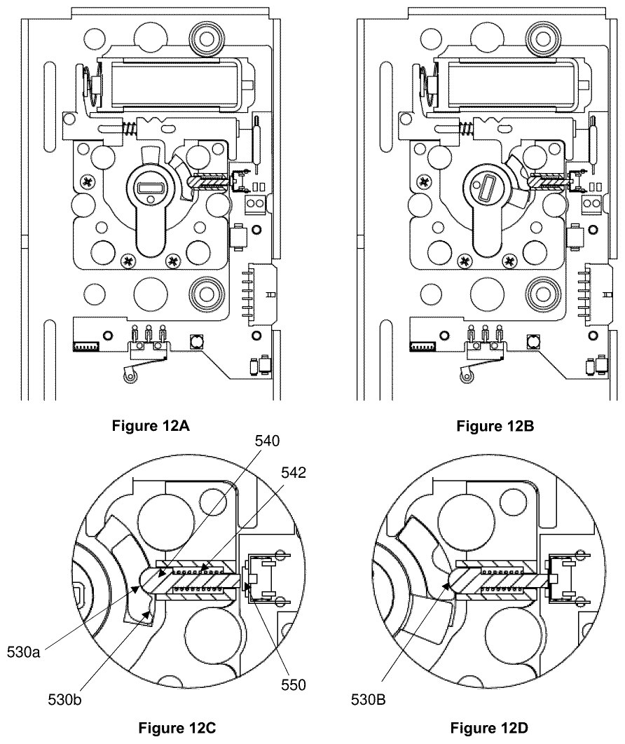

FIGS. 11 and 12 show a further feature that may be included in embodiments of the invention. As mentioned, the deadbolt 182 may be thrown and retracted by action of a key cylinder or solenoid. The solenoid may form part of an electronic access control system. For example, the access control system may cause the solenoid to be retracted when a user enters a correct numeric or alphanumeric key on a key pad or alternatively presents a correct swipe card at a sensor. In a lockdown situation when it is desirable to rapidly secure a property against aggressive intruders it may be desirable to isolate the access control system so that persons external to the building cannot enter the building. By isolating the access control system, we are effectively stopping entry from the outside by use of the access control system. This is useful in situations where an aggressive intruder may have stolen an access control card or is forcing an employee at the building to enter a numeric PIN. FIGS. 11A-11C are plan views showing an embodiment of a deadlock assembly configured to isolate the solenoid when a key cylinder is turned in the deadbolt assembly. FIGS. 12A and 12B shows parts of the deadbolt assembly exposed and FIGS. 12C and 12D are close-up views of part of the deadbolt assembly.

In FIG. 11A the key cylinder 184 that has been previously discussed is shown. The key cylinder comprises rotatable cam 510 which rotates when a matching key is inserted into the key cylinder and the key is turned. The deadbolt 182 comprises a protrusion 520 which extends into the path of the cam 510. In FIG. 11A the cam is shown at the rest position in which the key can be inserted and removed from the key cylinder. The cam is at the top of the rotation path around the key cylinder. On insertion and turning of key clockwise the cam 510 rotates clockwise pushing against the projection on the deadbolt to retract the deadbolt. On turning of key anti-clockwise from the rest position the cam hits rotational slider 530. Rotational slider sits in the path of the cam when the key is turned to throw the deadbolt. Rotational slider is arc-shaped. As shown in FIG. 11C the rotational slider 530 comprises two recesses 530a, 530b. The recesses may be scallop-shaped. The first recess 530a is deeper than the second recess 530b. A plunger 540 is located next to the rotational slider and has an end-face that may align and alternately insert into each of the two recesses depending on the position of the rotational slider 530. Plunger 540 is biased towards the rotational slider by spring 542. At the other end of plunger and fixed to the deadbolt assembly is a switch 550. This may be a microswitch. The switch is arranged to align with the end of the plunger distal to the rotational slider.

We now describe operation of the deadbolt assembly. FIGS. 12A and 12C are views of the deadbolt assembly corresponding to FIG. 11A in which the cam 510 of the key cylinder is at the rest position. The deadbolt is thrown blocking retraction of the bolt 111 and drive members 140, 145. In FIGS. 12A and 12C the plunger 540 can be seen to extend into the upper recess or first recess 530a of rotational slider 530. As this recess is deeper than the second the plunger extends further into the rotational slider than if in the second recess. The distal end of plunger is not pressing the switch 550. Since the switch is configured to be “on” or “uninterrupted” when not pressed, the solenoid remains active and the access control is active for retracting the deadbolt 182. In FIG. 11B and as shown in FIGS. 12B and 12D the cam is rotated from rest anticlockwise and pushes rotational slider upwards such that the plunger moves into second recess 530b. As this recess is not as deep, the distal end of the plunger pushes against the switch 530b. In this configuration the switch is “off” or provides an “interrupt” and turns off the solenoid such that it is not operated by the access control system. The switch may simply interrupt or let pass signals or power from the access control system to the solenoid depending on the position of the rotational slider and plunger. Alternatively, a controller such as comprising a microprocessor may receive a signal from the switch indicating whether the switch is pressed or not. Based on the signal the controller determines whether power is supplied to the solenoid or not.

In FIG. 11C the cam has been rotated a small amount anti-clockwise. The cam 510 pushes against protrusion 520 on deadbolt retracting the deadbolt to allow the bolt 111 and drive members 140, 145, to be retracted. Here the protrusion pushes against the opposite end of the rotational slider pushing it such that the plunger moves from extending into the second recess 530b to extending into the first recess 530a. Hence, the rotational slider and switch are reset with the access control and solenoid again being active.

We have described above how the lockdown assembly 300 releases the bolts or primes the bolts to be released when the lockdown button 132 is pushed. In an alternative arrangement the lockdown assembly may be configured to hold the bolts in the thrown position securing the door closed, and on pressing of the lockdown button the bolts would be primed for release. Turning of a handle or key cylinder would then retract the bolts. A lockdown assembly 300 corresponding to that described in relation to FIGS. 8A-8D would be used but would interact with the drive member 140 at a different position. The bolt(s) 120 and drive members 140, 145 are biased by a relatively strong spring such that as soon as they are released (and any bolt restraint is also released) the bolts throw. In FIGS. 4-7 the plunger 302 of lockdown assembly 300 engages in drive member 140 at position in which the drive member is in a retracted position. For the alternative arrangement, the plunger engages in the drive member at a different position, with the drive member in the thrown position. Such a “held in the thrown position” arrangement would require the lockdown button to be first pressed to prime the release of the bolts, then a user to operate the handle (or key cylinder) to exit. When the bolts re-secure upon closing the door, the lockdown assembly would reset and hold the bolts in the thrown position again. Similar aspects as described in the preceding figures may be included, such as a latch, indicators and links to access control.

In a further alternative arrangement, a modified version of the lockdown assembly could be used as a hold-back assembly. In such an arrangement the door would normally be secured with bolts thrown. The hold-back assembly would not include a lockdown button but would include a plunger which engages with the bolt or drive members when the bolts or drive members are retracted. Release of the bolts for throwing would be by a key cylinder in a similar manner to that described in the preceding paragraph. Accordingly, a bolting mechanism may comprise a hold-back assembly including a hold-back plunger. The hold-back plunger, is similar to the plunger described for other embodiments and is movable between a blocking position and a retracted position. The hold-back plunger is biased by a second bias to engage with one of the drive members and block throwing of the at least one bolt. The bolting mechanism may further comprise a key cylinder arranged to retract the hold-back plunger and release the at least one bolt to move or ready to be moved to the thrown position. In this embodiment, the bolts and drive members would be usually thrown securing the door, such as for a fire exit door. When the door is opened and the bolts are retracted (such as by turning a handle operating a rotor), the hold-back plunger engages in a recess in one of the bolts or drive members and holds the bolt(s) back in the retracted position. To reset the device, a person with a key matching the key cylinder is required to turn the key cylinder to reset the plunger. By holding the bolt(s) back it is possible to monitor and highlight that somebody has operated the device in an attempt to exit though that particular doorway. Hence, an unauthorised person (i.e. without a key) would not be able to reset the device to surreptitiously cover their tracks.

The person skilled in the art will readily appreciate that various modifications and alterations may be made to the above described bolting mechanism. The modifications may be made without departing from the scope of the appended claims. For example, the plunger may be configured to block retraction and/or throwing of the bolt, and the plunger may be released by any of a push button, turn-knob, key cylinder etc. Furthermore, in examples the bolting mechanism, may comprise only a single bolt and may include only a single drive member. The rotors of the bolting mechanism may be configured differently such as without teeth but to drive each other by lever action or the use of a belt or chain. The solenoid may be replaced with a motor such as a worm drive motor providing linear movement in a similar manner to the solenoid. Furthermore, variations in the actual shapes of the parts such as the latch bolt, plunger, lockdown button, deadbolt, cam, and button rest plate etc. may be made without diverging from the general scope of the present invention.

What is claimed:

1-29. (canceled)

30. A bolting mechanism with a lockdown mode, the bolting mechanism comprising:
at least one bolt, the at least one bolt moveable between a thrown position and a retracted position, the thrown position for securing a door;
at least one first rotor arranged to simultaneously drive the at least one bolt and one or more drive members;
a first bias arranged to drive the at least one first rotor to urge the at least one bolt to the thrown position; and
a lockdown assembly comprising a lockdown button and plunger, the plunger movable between a blocking position and a retracted position,
wherein the plunger is biased by a second bias to engage with one of the drive members and block throwing of the at least one bolt, and
the lockdown button is arranged to release the plunger such that the first bias throws the at least one bolt or primes the at least one bolt ready to be urged to the thrown position.

31. The bolting mechanism of claim 30, wherein the second bias is weaker than the first bias such that the first bias is arranged to drive the at least one bolt and push the plunger to a retracted position.

32. The bolting mechanism of claim 30, wherein the plunger comprises a ball and pushrod, and the one of the drive members comprises a recess arranged to receive at least part of the ball to block throwing of the at least one bolt.

33. The bolting mechanism of claim 30, wherein the lockdown button comprises a stem, the stem having a foot arranged to block retraction of the plunger when the plunger is in the blocking position and until the button is pressed.

34. The bolting mechanism of claim 33, wherein the lockdown assembly further comprises a button reset plate and the lockdown button comprises a heel, the button reset plate arranged such that when the button is pressed the button reset plate catches against the heel to hold the lockdown button in the pressed position.

35. The bolting mechanism of claim 34, wherein the heel and button reset plate are arranged to move transversely to each other, the heel and button reset plate having wedge surfaces arranged such that pushing of the lockdown button causes the wedge of the heel to move past the wedge of the button reset plate to latch the lockdown button in the pressed position.

36. The bolting mechanism of claim 34, further comprising an indicator lever coupled to the button reset plate, the indicator lever having a free end that moves as the button reset plate moves, the free end of the indicator lever arranged to show an amount of movement that is greater than the amount of movement of the button reset plate.

37. The bolting mechanism of claim 36, wherein the indicator lever is arranged to indicate two or more positions of the button reset plate, the two or more positions indicating two or more of:
i) the at least one bolt is retracted;
ii) the lockdown button has been pressed and the at least one bolt is primed to throw; and
iii) the at least one bolt is thrown.

38. The bolting mechanism of claim 34, wherein the one of the drive members comprises a release tab, the release tab arranged such that when the at least one bolt moves to the thrown position the release tab pushes the button release plate to release the lockdown button.

39. The bolting mechanism of claim 38, further comprising a bolt status indicator window, the one of the drive members comprising first and second indicator portions, the indicator portions arranged on the one of the drive members such that when the at least one bolt is in the thrown position the first indicator portion is visible through the bolt status indicator window and when the at least one bolt is in the retracted position the second indicator portion is visible through the bolt status indicator window.

40. The bolting mechanism of claim 39, wherein the release tab comprises the first and second indicator portions.

41. The bolting mechanism of claim 40, wherein the one of the drive members comprises a recess arranged to receive the button reset plate when the one or more bolts are in the retracted position.

42. The bolting mechanism of claim 30, further comprising a deadbolt assembly comprising a deadbolt movable between an extended position and a retracted position, wherein in the extended position the deadbolt extends into a first notch in the one or another of the one or more drive members to block retraction of the at least one bolt.

43. The bolting mechanism of claim 42, further comprising a latch assembly, the latch assembly comprising:
a latch bolt; and
a latch rotor assembly comprising one or more second rotors,
wherein the latch bolt is biased to a thrown position and one of the one or more second rotors is configured to be rotated by a handle or key cylinder to retract the latch bolt, the one of the one or more second rotors further arranged to drive the one or another of the one or more drive members to retract the at least one bolt.

44. The bolting assembly of claim 43, wherein the one of the one or more second rotors is an inside second rotor arranged to be driven by a handle on the inside of a door or a key cylinder,
the latch assembly further comprising:
an inside latch slider arranged to be driven by the inside second rotor to retract the latch bolt;
a drive member inside slider arranged to be driven by the inside second rotor to move the drive member to retract the at least one bolt.

45. The bolting mechanism of claim 44, wherein the drive member inside slider comprises a notch to receive the deadbolt, the notch having a ramp surface such that when the drive member is driven by the inside second rotor the ramp surface pushes against the deadbolt to move the deadbolt to the retracted position.

46. The bolting mechanism of claim wherein the latch rotor assembly further comprises:
an outside second rotor arranged to be driven by a handle or key cylinder on the outside of the door, and the latch assembly further comprises:
an outside latch slider arranged to be driven by the outside second rotor to retract the latch bolt;
a drive member outside slider arranged to be driven by the outside second rotor to move the drive member to retract the at least one bolt;
wherein drive member outside slider comprises a notch into which the deadbolt extends, the notch having square sides blocking retraction of the at least one bolt.

47. The bolting mechanism of claim 44, wherein the drive member comprises a second notch for receiving the deadbolt, the second notch having a ramp surface to override the deadbolt when the at least one bolt is moving to the thrown position.

48. The bolting mechanism of claim 34, wherein the deadbolt assembly comprises a solenoid arranged to move the deadbolt between retracted and thrown positions.

49. The bolting mechanism of claim 48, further comprising an electronic sensor configured to monitor whether the at least one bolt is in the thrown position or the retracted position, the bolting mechanism configured such that:
if the electronic sensor detects that the at least one bolt is in the thrown position, the solenoid is disabled; and/or
if the electronic sensor detects that the at least one bolt is in the retracted position, the solenoid is disabled.

50. The bolting mechanism of claim 34, wherein the deadbolt assembly comprises:
a key cylinder, the key cylinder having a cam rotatable on insertion of a matching key, the cam arranged such that on rotation the cam pushes against a protrusion on the deadbolt to retract and throw the deadbolt; and
a switch arranged to be operated as the cam is rotated, wherein one of pressing or releasing the switch disables the solenoid and the other of pressing or releasing the switch enables the solenoid.

51. The bolting mechanism of claim 50, wherein the deadbolt assembly comprises:
a rotational slider arranged to move along an arc when pushed by the cam of the key cylinder; and
a sprung plunger biased to respectively move into first and second recesses in the rotational slider depending on the rotational position of the rotational slider, the first recess being deeper than the second,
wherein the deadbolt assembly is configured such that on rotation of the cam to a first position the sprung plunger extends into the first recess and the switch is released, and the on rotation of the cam to a second position the sprung plunger extends into the second recess and the switch is pressed.

52. The bolting mechanism of claim 30, wherein the at least one bolt comprises: a first laterally movable bolt for securing the side of a door.

53. The bolting mechanism of claim 52, further comprising:
a first vertically movable bolt configured to move vertically upwards for securing the top of a door and driven by one of the one or more drive members; and/or
a second vertically movable bolt configured to move vertically downwards for securing the bottom of a door and driven by another of the one or more drive members.

54. The bolting mechanism of claim 53, further comprising a bolt restraint for restricting throwing of the first or second vertically movable bolt until the door is closed, the bolt restraint comprising an actuator arranged to be pushed against a door frame as the door is closed releasing the bolt for throwing.

55. The bolting mechanism of claim 52, further comprising:
a second laterally moveable bolt for securing the side of a door, the second laterally movable bolt spaced downwards from the first laterally movable bolt, the second laterally movable bolt arranged to be driven by a first auxiliary bolt driver driven by one of the one or more drive members; and/or
a third laterally moveable bolt for securing the side of a door, the third laterally movable bolt spaced upwards from the first laterally movable bolt, the third laterally movable bolt arranged to be driven by a second auxiliary bolt driver arranged to be driven by another of the one or more drive members.

56. A bolting mechanism with a lockdown mode, the bolting mechanism comprising:
at least one bolt, the at least one bolt moveable between a thrown position and a retracted position, the thrown position for securing a door;
at least one first rotor arranged to simultaneously drive the at least one bolt and one or more drive members;
a first bias arranged to drive the at least one first rotor to urge the at least one bolt to the thrown position; and
a lockdown assembly comprising a lockdown button and plunger, the plunger movable between a blocking position and a retracted position,
wherein the plunger is biased by a second bias to engage with one of the drive members and block retracting of the at least one bolt, and
the lockdown button is arranged to release the plunger such that the at least one bolt is ready to be moved to the retracted position on action of a handle or key cylinder driving the at least one first rotor.

57. A bolting mechanism with a hold-back mode, the bolting mechanism comprising:
at least one bolt, the at least one bolt moveable between a thrown position and a retracted position, the thrown position for securing a door;
at least one first rotor arranged to simultaneously drive the at least one bolt and one or more drive members;
a first bias arranged to drive the at least one first rotor to urge the at least one bolt to the thrown position; and
a hold-back assembly comprising a hold-back plunger, the hold-back plunger movable between a blocking position and a retracted position, wherein the hold-back plunger is biased by a second bias to engage with one of the drive members and block throwing of the at least one bolt, and
a key cylinder arranged to retract the hold-back plunger and release the at least one bolt to move or ready to be moved to the thrown position.

58. A bolting mechanism with latch, the bolting mechanism comprising:
at least one bolt, the at least one bolt moveable between a thrown position and a retracted position, the thrown position for securing a door;
at least one first rotor arranged to simultaneously drive the at least one bolt and one or more drive members
a bias arranged to drive the at least one first rotor to urge the at least one bolt to the thrown position;
a latch assembly comprising a latch bolt and a second rotor, the latch bolt biased to a thrown position and the second rotor configured to be rotated by a handle to retract the latch bolt, the second rotor further arranged to drive the at least one drive member to retract the at least one bolt.
